(19) United States
(12) Patent Application Publication
(10) Pub. No.: US 2007/0023959 A1
(43) Pub. Date: Feb. 1, 2007

(54) Moulding method and apparatus

(75) Inventors: Stephen J. Wilkinson, Cornwall (GB); Norman I Frost, Cornwall (GB)

Correspondence Address: GIFFORD, KRASS, GROH, SPRINKLE & CITKOWSKI, P.C, PO BOX 7021, TROY, MI, 48007-7021, US

(73) Assignee: Movevirgo Ltd., Cornwall (GB)

(21) Appl. No.: 10/576,846

(22) PCT Filed: Oct. 20, 2004
(86) PCT No.: PCT/GB04/04440

§ 371 Date: Jul. 17, 2006

(30) Foreign Application Priority Data
Oct. 21, 2003 (GB) 0324521.4

(51) Int. Cl. B29C 45/14; B29C 33/00; B28B 7/08

(52) U.S. Cl. 264/265; 264/279; 249/137; 249/117; 249/83

(57) ABSTRACT

A method of moulding an article having a relatively small thickness in relation to its dimensions in plan including providing a mould for the article, locating or forming one or more inserts on a mould face which will define a part of the surface of the moulded article, introducing the material to be moulded into the mould, providing attachment means with an irregular surface in contact with the material, maintaining the mould in such an orientation while the material hardens and mechanically bonds to the attachment means, such that the said mould face is inclined to the horizontal at an angle at which the or each insert is retained on the said face against slipping by friction during the hardening of the material, and providing gas-outlet means from an upper part of the mould in the said orientation to allow the escape of gases during the moulding process. The attachment means is treated on one face or provided with knit loops so as to adhere to the material of the article during curing.

The technical background of the present invention is the moulding of articles and particularly, but not exclusively the moulding of articles having a relatively small thickness in comparison with their dimensions in plan. Such articles may be generally planar but do not necessarily have to be.

The present invention also comprehends a method of moulding an article. The invention is particularly concerned with the moulding of signs and especially signs in which characters or other indicia are set in a supporting substrate so as to be visible on at least one face thereof.

One of the problems encountered with moulding processes is that bubbles of gas (in particular air) may form and/or become trapped within the material during casting or pouring and, if they are allowed to remain, can have a detrimental effect on the finished article. Such bubbles can, of course, escape if the moulding is carried out in an open mould (that is one in which the upper surface of the material being moulded is freely open to the atmosphere or, at least, to an atmosphere within the mould itself) but, where the upper surface of the moulded article contacts the mould or a mould insert, appropriate escape routes must be provided for any trapped gases.

When the article being moulded has a substantial bulk, outlets in the upper part of the mould can provide adequate venting but, when the article being moulded is relatively thin and flat, effective venting is more difficult to achieve. In particular, small bubbles may be trapped between the upper surface of the moulded material and the mould face causing tiny cavities in this surface in the finished article. This problem is aggravated when the moulded article has a generally flat surface with inserts or cavities therein which are formed by inserts or mould parts on the bottom face of the mould where gas bubbles may become trapped during the filling of the mould.

According to one aspect, therefore, the present invention provides a method of moulding a generally flat article including the steps of:
providing a mould for the article,
locating or forming one or more inserts on a mould face which will define one surface of the moulded article,
introducing the material to be moulded into the mould,
providing attachment means with an irregular surface in contact with the material,
maintaining the mould in such an orientation while the material hardens and mechanically bonds to the attachment means, such that the said mould face is inclined to the horizontal at an angle at which the or each said insert is retained on the said face against slipping by friction, and
providing gas-outlet means from an upper part of the mould in the said orientation whereby to allow the escape of gases during the moulding process.

Thus, gas bubbles which might otherwise be trapped at the upper surface of the flat article are vented by providing for the mould to be tilted so that even gas in contact with an upper face of the mould will rise automatically to the uppermost part of the mould where the bubbles will coalesce and can readily be vented through one or more ducts to the exterior. This, in itself, provides an effective way of moulding a flat article. The invention results, in particular, from a realisation that such a flat article can readily be moulded with inserts in a very simple and economical way if the inserts are simply placed (or formed in situ) on the lower mould face, provided the mould is not tilted to an angle at which such inserts would start to slip. The inserts are thus retained in position by friction, no other retainer means being required.

The mould inserts may be releasable from the moulded article, forming cavities therein, to allow articles having relatively complex inserts to be formed easily and economically and with the added advantage that the shapes of the inserts may readily be changed to allow a range of articles to be moulded without the expense of providing an entirely new mould for each variant. This not only allows signs of a given shape and size to be produced having different message-defining inserts but also signs of different size and shape by making the, or at least one, of the inserts a full mould thickness effectively to define an edge of the mould cavity. Alternatively, and in the particular application to which the invention is directed, inserts may be retained in the finished article: the retention may be achieved by the particular shaping of the insert which forms a key with the moulded article and/or by direct bonding of the insert and moulding materials and/or by an adhesive layer applied to the inserts before the filling of the mould with the material to be moulded and/or by other suitable means. In the preferred application of the invention, direct bonding is employed.

The preferred use of the invention, to which reference will be made below without thereby departing from the generality of the invention, is in the moulding of underwater signs for which special plastics materials with anti-fouling properties are required. Such plastics are known in the art and do not form part of the present invention and will not, therefore, be specified in detail although, in general, it will be appreciated that they need to be waterproof, sufficiently tough and durable to withstand the battering and abrasion to which they may be subject, particularly in a submarine environment, and must not provide a surface on which underwater organisms, such as algae and shellfish, can cling as these would gradually obscure the signs. To this latter end, such plastics materials have very low friction surfaces and the surfaces must also be free from asperities.

Preferably, the moulding material is a silicone. The silicone material may comprise one or more of RTV 325, M polymer, XE15-4283, T4, TSE 3455, ELM 4541, RTV 3040, PR910/1101, PR110/30, RTV 430, ELM 4514, although any other suitable silicone may be used.

In view of the above requirements, it has been found that underwater signs need to have very smooth surfaces, especially the surfaces bearing the message, and it is not acceptable for message elements to be applied to the surface, for example by painting because this results in surface discontinuities at which the aggressive attack of the corrosive medium (i.e. seawater) can commence or, more importantly, allows organisms a foothold on which they can build. Thus, the moulding method of the invention is particularly suitable in that it allows inserts of one material, forming the elements of a message, to be moulded into a face of a body, or sign, so as to be substantially co-extensive with that surface when the body has cured, set or hardened.

In practice, the outer surfaces of the inserts must have similar properties to those of the main body of the sign. For producing signs for other purposes than submarine use the inserts could be of a different nature from the sign body, even as far as surface form is concerned, as well as being a different colour or being otherwise visually distinguishable from the body of the sign, for example by having a different surface texture.

In view of the properties required for submarine signs it would obviously be convenient to use substantially the same materials both for the body of the sign and for the message inserts (apart from a colour difference) but because the properties of the material are such that, once it has cured, it does not adhere to other previously cured bodies, even those of the same material it is not possible to pre-form the message inserts and place them in the mould for the sign body before casting the body material around them, nor is it possible to mould the sign body with appropriate cavities and subsequently cast the latter material into them.

It has been found, however, that there is a way by which it is possible to use anti-fouling plastics for the mould inserts provided they are used in a partially-cured state, in which they have sufficient cohesion to retain their shapes but have not cured, set or hardened fully; in such a condition they can still bond to the body material as it cures.

Accordingly the invention further provides the steps of pre-moulding the inserts from a plastics material and using the pre-moulded inserts in a partially-cured state as the inserts for the moulding of the finished flat article, the insert material curing and bonding to the body of the article during the curing of the latter.

In the case of a sign which is to display a message made up from several parts, whether these are characters, pictograms or other indicia, then each insert constituting part of the message must be placed in a specific spatial relationship with the other inserts on the mould face before the moulding operation. For this purpose, the indicia may be pre-made, separate from each other and from the mould for the sign body, and arranged manually or robotically on the mould face. More preferably, however, they are moulded directly on the mould face by means of auxiliary mould means that may be removed once the inserts have cured sufficiently to be substantially cohesive. More particularly, the inserts are preferably moulded in a single mould body formed so that they are at their correct mutual spacing and steps are taken to ensure that the body is appropriately located on the mould face so that the inserts are also located in their correct positions on that face in one simple operation. Conveniently the mould body is a template for the inserts and is placed on the mould face and its apertures filled with the raw insert material. In the case of the materials used currently for underwater signs, the raw material may be spread over the template, squeezed into the apertures and the upper surface scraped off but any method of application suitable to a particular material involved may be used.

The template used in the method of the invention may be cut by a so-called ‘template cutter’ and, advantageously, this may be controlled by a computer which can be programmed to determine the shape or shapes cut in the template so that a range of different messages may be formed. This enables the messages displayed by the signs produced by the method to be changed very readily, making short production runs an economic possibility.

It will be understood that the template, when placed on the mould face for forming the message must display the message in mirror-image for this to appear the right-way around to a viewer of the completed sign. It will also be appreciated that some indicia, such as a letter ‘R’ require an annular cut which would remove a central part of the letter. Bridges may be left to attach the centre to the periphery of the letter but, conveniently, temporary bridges may be applied to hold the centre in place while the template is transferred to the mould; this may be achieved for example by applying a transfer sheet to substantially the whole of one surface of the template to keep all such loose pieces in place during transfer.

In order to ensure that the template remains in its desired location on the mould face, it is preferably fixed in place by adhesive although it may be located or fixed by other means. The adhesives used in all stages may be releasable adhesives protected by release films when not in use. Such adhesives are well known in the art.

Submarine signs as discussed above are intended for attachment to submarine structures, such as oil rig legs, and must, therefore, not only be capable of displaying a message but must also be attachable to the structure. It will be appreciated that, once the sign material has cured, it can no longer be attached to a structure by adhesive because of its anti-adhesive properties. Holes could be formed so that it can be bolted to a structure but in such a case the bolts could themselves form sites for unwanted organic growth. The method of the invention therefore preferably includes a step of locating attachment means for attaching the finished article, or sign, to a support structure, in the mould for the flat article and moulding the article so that it is firmly attached to the attachment means when cured.

The attachment means may, for example, include members, such as straps, which project from the edges or rear face of the article when cured but, for simplicity, the attachment means comprise a sheet of material which is mechanically bonded to the back face of the article during moulding and which can itself be bonded to fixings or supports once the article is cured: a sheet of plastics material such as PVC, suitably treated on one face so as to adhere to the material of the article during curing, is preferred. Such a sheet of material may conveniently be placed on or in the mould part which will form the back face of the article before the mould is closed.

Preferably the attachment means is flexible.

Preferably the irregular surface of the attachment means comprises a mechanically scuffed surface. Alternatively, the irregular surface may comprise a chemically edged surface, a ribbed surface, an array of short hairs or bristles, an array of knitted loops, a velour, a looped Velcro-like surface, or the like.

Preferably the attachment means comprises an impermeable material, such as a vinyl material. Preferably the vinyl material is poly vinyl chloride.

The attachment means may comprise a combination of materials, for example, the attachment means may comprise nylon or velour-like hooks or loops with a pvc backing or another impervious backing that can be glued.

The mould for the flat article may be closed before or after filling with the material to be moulded depending on the nature of this material, the structure of the mould itself and the nature of any inserts. In use of the preferred material for forming an underwater sign, this has two constituents which must be mixed just before introduction into the mould but can be poured into the mould. Preferably the mixture is poured through an aperture provided in the mould in an upper position in its moulding orientation, the inlet aperture being separate from the vent aperture or apertures. Mixing may be carried out manually and/or in batches but such methods tend to be time-consuming and wasteful of materials. Hence a mixer/dispenser is preferably used which includes means for metering controlled amounts of the constituents into a vessel where they are mixed automatically to a more homogenous standard than achievable manually and further includes means for delivering the mixed ingredients to the mould. Such automated equipment would even more preferably operate with continuous supplies of the constituents to the mixing vessel and deliveries to a succession of moulds on a production line.

Once a mould is filled and closed, it must be maintained at an angle to the horizontal to ensure that gas is vented therefrom and is not trapped as tiny bubbles at the upper surface of the moulded material, whether this is between the moulded material and a plastics insert or between the moulded material and the mould itself. As it is easier to locate the inserts on a horizontal surface and, indeed, if inserts are moulded on the mould face by means of a template, this step must be carried out on a horizontal surface, the mould is preferably tilted to the curing position once the inserts have been located and any auxiliary mould parts have been removed and more usually, before filling with the material to be moulded.

According to another aspect of the invention, there is provided apparatus for moulding a generally flat article, comprising a shallow mould part with a flat mould face which will define an under surface of the moulded article, inserts or means for forming inserts for location on the said mould face, attachment means for mechanical bonding to the material, means for closing the mould, means for supporting the closed mould in an orientation in which the said mould face is inclined to the horizontal at an angle at which the or each insert is retained on the said mould face against slipping by friction, and means for venting gas from an upper part of the mould in the inclined position of the mould.

The apparatus may include any features described above in relation to the moulding method of the invention. In particular, it preferably includes means for supporting the mould with the flat, insert support face in a substantially horizontal position for the location or forming of the insert or inserts thereon and for moving the mould to its inclined position for the curing of the moulded article. Preferably the support means comprise a support frame or table pivotable between the substantially horizontal and the inclined positions.

Such a frame or table is preferably pivotally mounted on a base so as to be supported at a convenient working height for pivoting about a horizontal axis. The mould may be fixed to or incorporated in the frame or table or releasable therefrom and possibly interchangeable with other such moulds. Moreover the support frame or table may be pivotable in one or both senses from the horizontal position and may be fixable or lockable in any position, or in discrete positions, between the horizontal and a vertical position.

The mould itself preferably comprises two parts, a first, lower part defining the insert-support face, and a second upper part which closes over, and seals with, the lower part. In a preferred embodiment of the invention, the mould is vacuum-sealed. This enables the mould to be closed and sealed very quickly and efficiently while the opening of the mould is equally convenient.

One embodiment of the invention will now be more particularly described, by way of example, with reference to the accompanying drawings, in which:

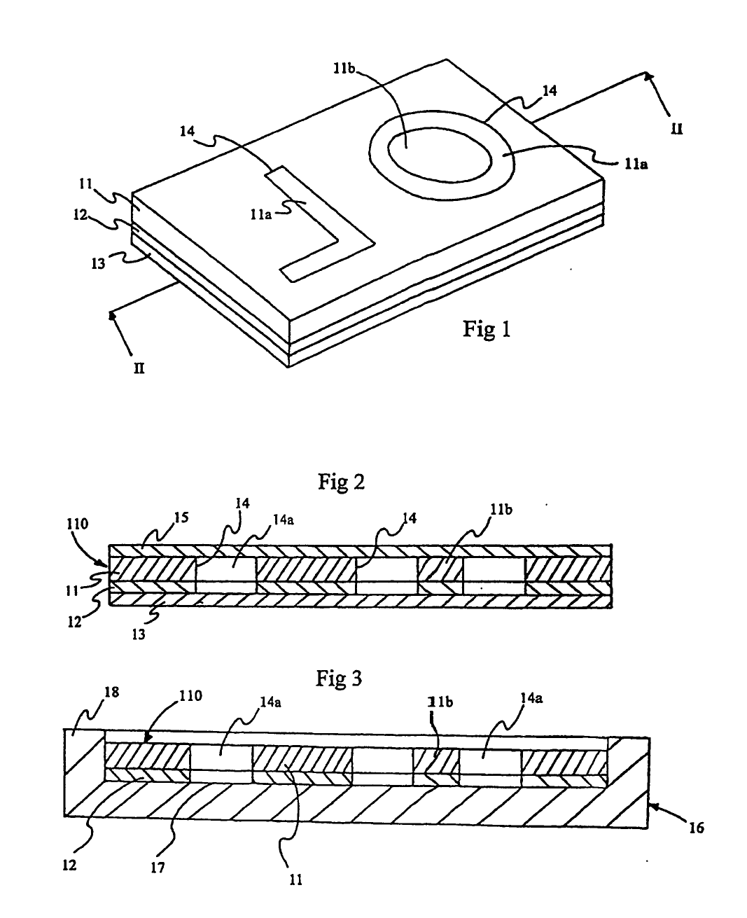

FIGS. 1 to 6 show schematically successive steps in the production of a sign according to the invention, the dimensions being exaggerated for clarity of illustration;

FIG. 7 is a schematic perspective view of part of equipment usable in the production of a sign according to the invention;

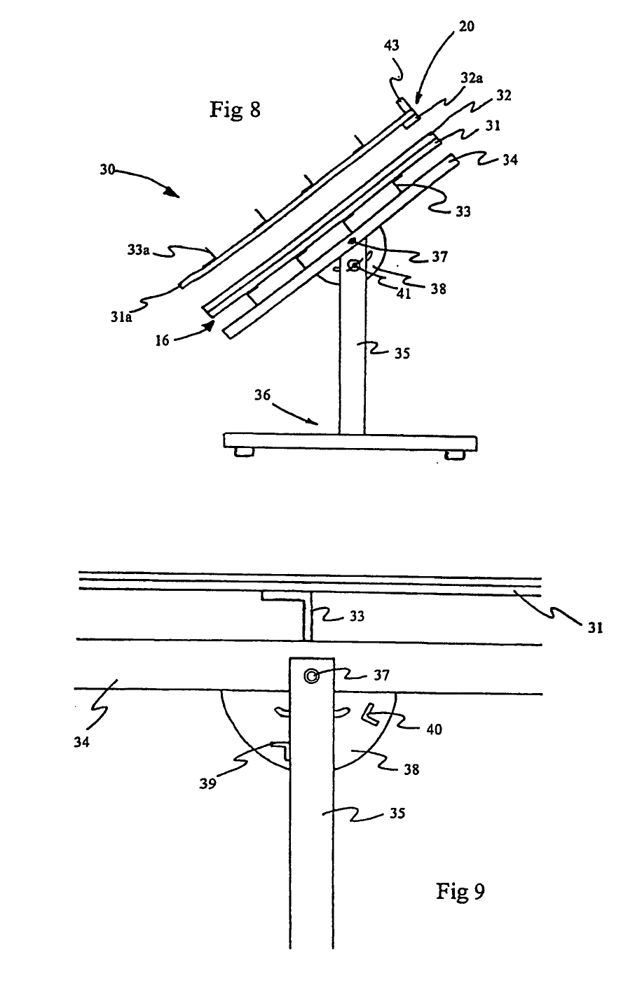

FIG. 8 is an end elevational view taken in the direction of the arrow VIII of FIG. 7, also showing an upper mould part of the equipment;

FIG. 9 shows a detail of the equipment of FIG. 7 on an enlarged scale; and

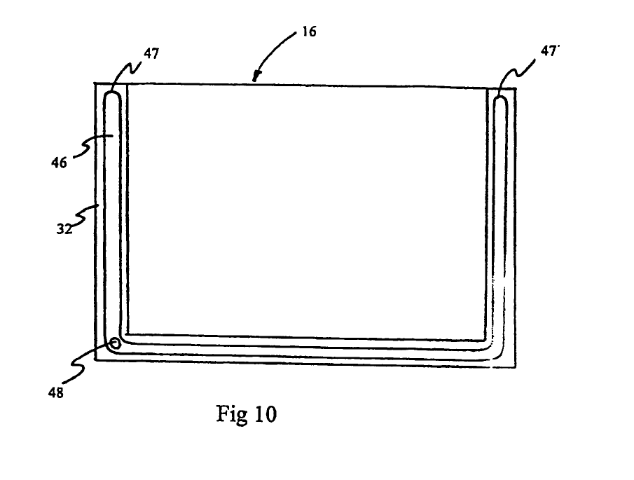

FIG. 10 is a diagrammatic plan view of a variant of a mould part of the equipment.

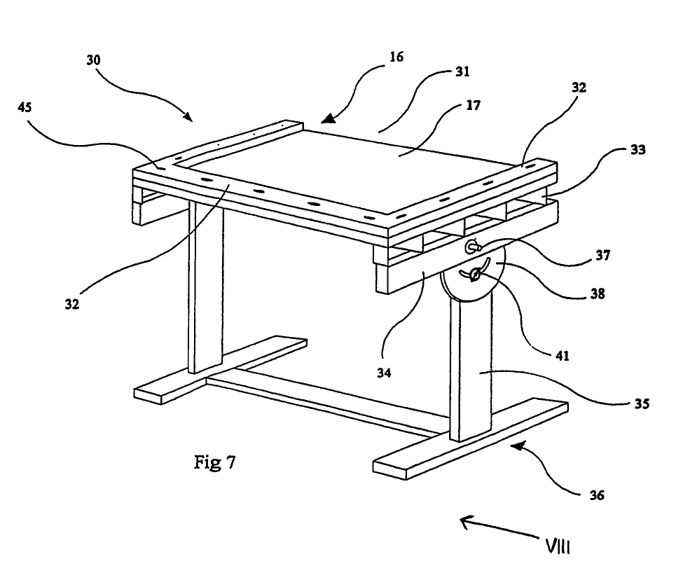

With reference to FIGS. 1 to 6, these show various steps in the production of a sign, generally indicated 10 in the final FIG. 6 of the series, particularly for underwater use.

FIG. 1 is a perspective view showing a step in the production of a template 110 (FIG. 2) formed from a sheet 11 backed by a coating of adhesive 12 and a release lining sheet 13. The outlines 14 of the characters, which will subsequently constitute the content of the sign, have been cut in the relative positions they are to occupy in the sign but in mirror image.

The character outlines 14 are cut by a sign cutter (not shown) preferably controlled by a computer such that the information displayed by signs made by the process can readily be changed.

Once the outlines 14 have been cut, the pieces of sheet material 11a within the outlines 14 are removed, leaving apertures 14a, and an adhesive transfer sheet 15 is applied to the upper surface of the sheet 11 to hold loose parts surrounded by annular incisions, such as the centre 11b of the “O”, in position: this condition is shown in section in FIG. 2.

The release lining sheet 13 is next removed before the now-completed template 110 is placed in a first mould part shown at 16 in FIG. 3 for the forming of the characters. The template 11, as shown, occupies the entirety of a flat base face 17 of the mould 16 surrounded by upstanding peripheral walls 18 but it may occupy only a small area of this surface, with appropriate positioning so that the characters are in a desired relationship with the edges of the finished sign.

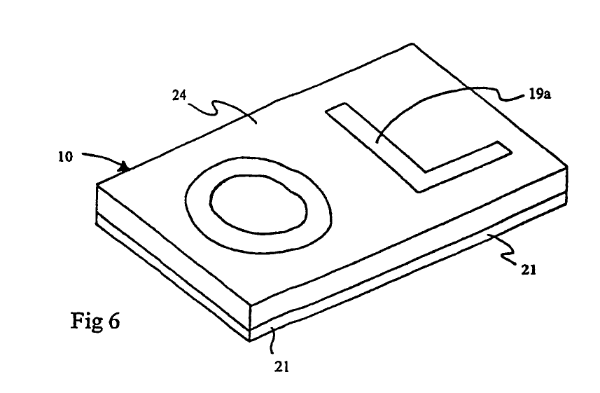

Once the template is positioned, the various sheet parts 11, 11b adhere to the first mould part 16 by means of the adhesive coating 12 and the transfer sheet 15, which also has a releasable adhesive coating, is removed. This stage is shown in section in FIG. 3: at this stage the base face 17 of the mould part 16 is horizontal although it could, alternatively be inclined to the horizontal as shown in FIG. 5.

The characters are next formed by the filling of the template apertures 14a with black or other coloured material 19 which has appropriate anti-fouling properties when hardened. The currently-preferred material is liquid and may be brushed, squeezed or sprayed into the template, or otherwise applied so that it fills the apertures 14a completely and the top surface is scraped flat.

The character material 19 is left to cure for a certain amount of time, sufficient to ensure that the characters will not deform either when the template 11 is removed or during the subsequent moulding process, described below, but not so much that they will not bond fully with the material subsequently co-moulded over them.

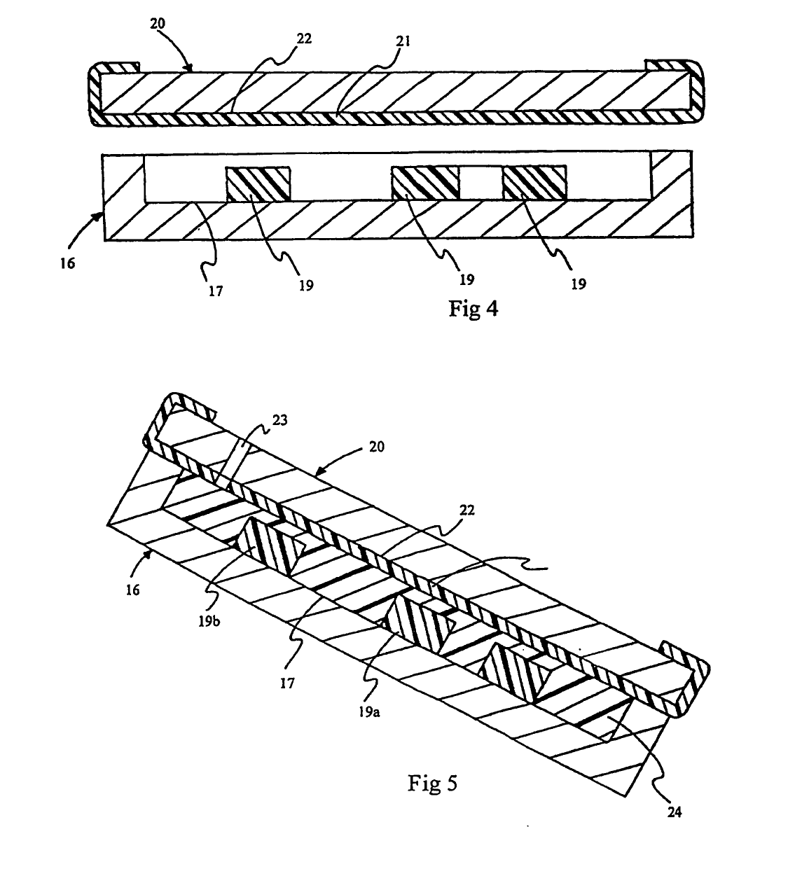

While the character material 19 is curing, a second mould part 20 (shown in the sectional view of FIG. 4 together with the first mould part 16) is prepared by the positioning of a backing sheet 21 on its flat surface 22 which is of the same size and shape as the base face 17 of the first mould part 16; such that the face of the backing sheet 21 not in contact with the flat surface 22 is provided with Velcro-like knit loops. The backing sheet 21 is currently preferably of plastics material, such as PVC, provided with Velcro-like knit loops on at least one surface, which may be secured in place by any suitable means depending on the nature of the mould part 20. In particular, the sheet 21 is currently secured by pins inserted through it into the mould itself but the use of vacuum clamping is envisaged. Additional backing sheets such as sheet steel are also envisaged and would be secured appropriately to the backing sheet 21.

Once the character material 19 has cured appropriately, the template 11 is removed and the second mould part 20 is closed over the first mould part 16, which at this stage is still horizontal or substantially horizontal and the mould is sealed. The completed mould 16, 20 is then tilted to the position shown in cross-section in FIG. 5, in which the base face 17 is inclined to the horizontal. The partially cured characters, here indicated 19a, 19b must be retained in their correct predetermined positions on the face 17 by friction and therefore the mould must not be tilted to a point at which they start to slip.

The mould cavity is next filled with uncured plastics substrate material 24 through an aperture 23 in an upper part of the mould, in the tilted position, while air escapes through outlets (not shown), also in the upper part, such that the mould can be filled without any air bubbles being trapped. The substrate material 24 is similar to the material 19 forming the characters 19a, 19b but of a different colour.

Once the mould is filled, the plastics substrate material 24 is allowed to cure at least to the stage at which it is cohesive before the mould is opened. The materials are selected such that, during the curing of the substrate material 24, the latter bonds both to the partly cured character material 19 and to the backing sheet 21. The three parts 19, 21 and 24 can thus be handled as a unit when the completed sign 10 is removed from the mould. The sign 10 is shown in perspective, the right-way up for viewing in FIG. 6, it having been moulded upside-down in the steps described above.

In the completed sign 10, the faces of the characters 19a, 19b are flush with the face of the sign itself, there being no asperities on which organic growths could take hold. Moreover, when cured, the materials 19, 24 forming the front face of the sign resist growth adhesion so that the message presented by the characters 19a, 19b will remain visible in the position of use in the long term.

With reference to FIGS. 7 to 9 of the drawings, equipment for moulding a sign 10 is shown generally indicated 30. Parts of the equipment equivalent to those shown in FIGS. 1 to 6 are indicated by the same references.

The equipment 30 thus includes a first, or lower, mould part 16 having a base, or moulding, face 17. The mould part 16 is in fact constituted by a sheet 31 of aluminium having rectangular section filets 32 of wood or other material secured to the face 17 along one longer and two shorter sides thereof to constitute the peripheral wall of the mould; the fourth side is left open.

In view of the thin flexible nature of the aluminium sheet 31, it is reinforced on the back by aluminium or mild steel angle sections 33 that extend parallel to the longer axis of the sheet 31. The angle sections 33 are in turn supported at each end by end-support angle sections 34 extending parallel to and beneath the shorter ends of the sheet 31.

Each end support section 34 is pivotally mounted at the upper end of a respective square-section upright 35 of a base frame generally 36 which supports the mould part 16 at a suitable height above the floor. The remaining structure of the base frame 36 will not be described as it is not relevant to the invention. What is relevant is that the pivot pins 37 attaching the mould part 16 to the uprights 35 are coaxial and parallel to the longer axis of the aluminium sheet 31 to enable this to pivot about a horizontal axis parallel to this longitudinal axis. The pivot pins 37 are readily releasable to enable the mould part 16 to be released from the base 36.

As best seen in FIG. 9, each end support section 34 of the mould part 16 also carries a semi-circular flange 38 which is dependent from it and lies adjacent the outer end face of the respective upright 35. The inner face of each flange 38 carries two projecting stops 39, 40 spaced apart around its periphery, each for contacting a respective outer side face of the upright 35; each stop 39 in practice contacts its upright 35 in the horizontal, or substantially horizontal position, of the sheet 31 shown in FIG. 7 to prevent the mould part 16 from pivoting beyond this position in one sense while the stops 40 contact the opposite faces of the uprights 35 to prevent pivoting in the opposite sense beyond the tilted position shown in FIG. 8.

A further feature of the base frame 36 are turn-clamps generally indicated 41, one carried on the outer end face of each upright 35 adjacent the outer edge of the respective mould flange 38. The clamps 41 are of generally known type but, in general, comprise a bolt passing through the upright and carrying a clamping plate and turn bar which can be rotated manually to clamp the adjacent flange 38 between the clamping plate and the upright 35 and thereby clamp the mould part 16 in a desired position against pivoting.

With reference now to FIG. 8 of the drawings, in particular, this shows the base frame 36 and lower mould part 16 together with an upper mould part 20.

The mould part 20 has a similar structure to that of the lower mould part 16 in that it is constituted by a sheet 31a of the same size as the sheet 31, reinforced on the back by angle sections 33a. It does not, however, have additional angle-section end supports equivalent to the supports 34, nor filets 32 along three sides. Instead it has one or more filet pieces 32a along one of its longer sides which, when the two mould parts are brought together, in use, mates with that side of the mould part 16 which does not carry the filet 32.

When the two mould parts 16, 20 are brought together, the filets 32, 32a ensure that the mould faces 17, 22 of the two parts are spaced uniformly apart. Gaps are however left between the fillet pieces 32a along one longitudinal edge which is uppermost in the tilted condition of the mould shown in FIG. 7.

For use of the mould part 20 for the manufacture of a sign as described above, the sheet 31a need not be of aluminium as it does not itself contact the material to be moulded: a sheet is placed over it before the moulding step. Instead a cheaper material may be used for the sheet 31a; a plastics coated chipboard edged with softwood is currently preferred for reasons indicated below.

In the embodiment shown in FIGS. 7 to 9, the two mould parts are clamped in this condition by clamping bolts (not shown) which pass through co-operating apertures (not shown) formed in the sheets 31, 31a and the filets 32, 32a.

In an alternative embodiment shown diagrammatically in FIG. 10, which will be described briefly below, the two mould parts are vacuum-clamped together.

A final feature of the mould part 20 is an inlet duct 43 connected to an aperture (not shown) in its moulding face and which communicates with the interior of the mould when the two parts are brought together.

In use of the equipment 30, the mould part 16 is first arranged with its face 17 horizontal while the template described above is used to form characters on it and then removed. A suitably-treated sheet (not shown) is then applied to the mould face 22 of the second mould part 20 so as the overlap the edges and is pinned in place by drawing pins inserted through the plastic sheet into the softwood edging strips. The second mould part 20 is then applied and clamped to the first mould part 16 and the entire mould is tilted to the position shown in FIG. 8.

The plastics material for forming the body of the sign is mixed and poured into the mould cavity through the duct 43 very quickly thereafter to avoid the characters curing to too great an extent. Any air in the mould escapes through the gaps between the filet pieces 32a along the upper edge of the mould. The mould may then be left for the plastics to cure before the completed sign is finally released from the mould.

With reference finally to FIG. 10 of the drawings, this shows a variant of the mould part 16. In this embodiment the clamping bolts and their apertures 45 are replaced by vacuum clamping means. For this purpose the filets 32 are widened and formed with a continuous channel 46 in their upper surfaces. The two ends 47 of the channel 46, close to the free ends of the filets 32, are closed but the channel communicates through an aperture 48 in its base with a vacuum source, not shown.

When the mould constituted by the parts 16 and 20 is closed, the channel 46 is evacuated so that atmospheric pressure clamps the two parts together. This provides a very much quicker method of clamping and releasing the mould parts than the use of clamping bolts.

### EXAMPLE

### Test of the Bonding Strength

Test samples were prepared sized 100 m×150 mm and tested using a clamp to hold the free end of the silicone attached to the hook of the measuring scales. A further clamp was used to hold the free end of the backing sheet of the samples. The scales were then attached to a chain block and the scales tensioned until there was separation of the two materials. This initial separation is used as the maximum load. Once separation of the silicon from the backing sheet occurred, the chain block was stopped immediately, and the load left connected to the clamps until the downward movement of the scale stabilised. This reading was taken as the sustained load.

The results of the bonding strength tests are shown below:

| | | | Load to | Sustained |
|---|---|---|---|---|
| Test No. | Backing | Silicone | start peel | Load |
| 1 | PVC | Wacker ‘m’ | 10 kg | 8 kg |
| | | polymer 355Z | | |
| 2 | PVC | Wacker ‘m’ | 11 kg | 8.5 kg |
| | | polymer 355Z | | |
| 3 | Aplix^{RTM} 200 | RTV 430 | 16 kg | 15 kg |
| 4 | Aplix^{RTM} 200 | RTV 430 | 16 kg | 15 kg |
| 5 | VELCRO^{RTM} 3607 | RTV 430 | 17 kg | 16.5 kg |
| | VELOUR | | | |
| 6 | VELCRO^{RTM} 3607 | RTV 430 | 16 kg | 15.5 kg |
| | VELOUR | | | |

PVC—Poly vinyl chloride
Aplix^{RTM} 200 - commercially available polyamide knit loop material (available from APLIX).
Velcro^{RTM} 3607 velour - commercially available vinyl laminate with a knit loop surface.

Samples 1 and 2 comprise a silicone moulding chemically bonded to a PVC backing sheet. Samples 3 and 4 comprise an RTV 430 moulding compound mechanically bonded to a vinyl backing. Samples 5 and 6 comprise an RTV 430 moulding compound mechanically bonded to Velcro™ velour, that is knit loops provided on a vinyl backing sheet.

As can be seen from the above table, samples 3 to 6 showed superior bonding strength when compared with samples 1 and 2. The mechanical bonding of the silicone moulding compound to the knit-loops on the backing sheet provides improved bond strength properties to the final moulded product when compared with the bonding strength properties of final moulded products relying on a chemical bond between the silicone moulding product and the backing sheet to provide bond strength.

1-25. (canceled)

26. A method of moulding an article having a relatively small thickness in relation to its dimensions in plan including providing a mould for the article,
locating or forming one or more inserts on a mould face which will define a part of the surface of the moulded article,
introducing the material to be moulded into the mould,
providing attachment means with an irregular surface in contact with the material,
maintaining the mould in such an orientation while the material hardens and mechanically bonds to the attachment means, such that the said mould face is inclined to the horizontal at an angle at which the or each insert is retained on the said face against slipping by friction during the hardening of the material, and
providing gas-outlet means from an upper part of the mould in the said orientation to allow the escape of gases during the moulding process.

27. A method according to claim 26 wherein the attachment means is a sheet.

28. A method according to claim 26 wherein the attachment means is flexible.

29. A method according to claim 26 wherein the irregular surface of the attachment means comprises a mechanically scuffed surface.

30. A method according to claim 26 wherein the irregular surface of the attachment means comprises a chemically etched surface.

31. A method according to claim 26 wherein the irregular surface of the attachment means comprises a ribbed surface.

32. A method according to claim 26 wherein the irregular surface of the attachment means comprises an array of short hairs or bristles.

33. A method according to claim 26 wherein the attachment means is provided with knit loops.

34. A method according to claim 33 wherein the attachment means has a looped Velcro-like surface.

35. A method according to claim 33 wherein the attachment means is a velour.

36. A method according to claim 26 wherein the attachment means comprises an impermeable material.

37. A method according to claim 26 wherein the attachment means comprises a vinyl material.

38. A method according to claim 37 wherein the vinyl material is poly vinyl chloride.

39. A method as claimed in claim 26, in which, during the introduction of the material to be moulded, the mould is supported in an orientation in which the said mould face is substantially horizontal and, after the introduction, is moved to an inclined orientation at an angle at which the or each insert is retained on the mould face against slipping by friction, for the article to set, cure or harden.

40. A method as claimed in claim 26, in which at least one insert is retained in the finished moulded article.

41. A method as claimed in claim 40, in which the said at least one insert to be retained is a partially-cured moulded article which sets, cures or hardens and bonds to the moulding material as this latter itself sets, cures or hardens.

42. A method as in claim 41, in which a plurality of the said inserts are moulded in a single mould body so shaped that the inserts have a predetermined spacing and orientation, which is maintained as the inserts are transferred to their position on the said mould face.

43. A method as claimed in claim 41, in which the or each insert to be retained is moulded directly on the mould face by means of subsidiary mould means which are removed when the insert has cured sufficiently to be at least substantially cohesive.

44. A method as claimed in claim 41, in which the subsidiary mould means comprise a template having cut-out portions defining the or each insert, and material for forming the insert is applied to the apertures in the template.

45. A method as claimed in claim 44, in which the template is placed in contact with the said mould face and the material for forming the insert applied thereto by spatula and scraped off level with the surface of the template.

46. A method as claimed in claim 42, in which a transfer sheet is applied to a partly cured insert to maintain the component parts thereof in a predetermined relative orientation and/or spacing upon transfer from the said mould body to the said mould face.

47. A method as claimed in claim 43, in which the template is cut by a cutter controlled by computer means which is programmable to determine the shape or shapes of the cut-out portions to be changed to form different inserts.

48. Apparatus for moulding an article having a relatively small thickness in relation to its dimensions in plan comprising a shallow mould part with a flat mould face which will define an under surface of the moulded article, inserts or means for forming inserts for location on the said mould face, attachment means for mechanical bonding to the material, means for closing the mould, means for supporting the closed mould in an orientation in which the said mould face is inclined to the horizontal at an
angle at which the or each insert is retained on the said mould face against slipping by friction, and means for venting gas from an upper part of the mould in the inclined position of the mould.

49. A moulded sign for underwater use having a relatively small thickness in relation to its dimensions in plan comprising a layer of moulded material in a first colour and containing at least one pre-moulded insert of a second colour, the sign further comprising attachment means moulded into the sign, wherein the attachment means has first and second major faces opposite one another, wherein the first major face is moulded in contact with the layer of moulded material of the first colour, and the second major face is left exposed, and wherein the first major face has an irregular surface.

50. A moulded sign according to claim 49 wherein the attachment is a sheet.

51. A moulded sign according to claim 49 wherein the attachment means is flexible.

52. A moulded sign according to claim 49 wherein the irregular surface of the attachment means comprises a mechanically scuffed surface.

53. A moulded sign according to claim 49 wherein the irregular surface of the attachment means comprises a chemically etched surface.

54. A moulded sign according to claim 49 wherein the irregular surface of the attachment means comprises a ribbed surface.

55. A moulded sign according to claim 49 wherein the irregular surface of the attachment means comprises an array of short hairs or bristles.

56. A moulded sign according to claim 49 wherein the attachment means is provided with knit loops.

57. A moulded sign according to claim 49 wherein the attachment means has a looped Velcro-like surface.

58. A moulded sign according to claim 49 wherein the attachment means is a velour.

59. A moulded sign according to claim 49 wherein the attachment means comprises an impermeable material.

60. A moulded sign according to claim 49 wherein the attachment means comprises a vinyl material.

61. A moulded sign according to claim 60 wherein the vinyl material is poly vinyl chloride.

62. A moulded sign as claimed in claim 49, in which the said at least one insert is partially-cured.

63. A moulded sign as claimed in claim 49, in which the said at least one insert is bonded to the layer of moulded material of the first colour.

64. A moulded sign as claimed in claim 49 comprising a plurality of the said inserts.

65. A moulded sign as claimed in claim 64, in which the plurality of inserts have a predetermined spacing and orientation.

66. A moulded sign as claimed in claim 49, in which the moulded material is silicone.

67. A moulded sign as claimed in claim 49, in which the moulded material has very low friction surfaces and anti-fouling properties.

68. A moulded sign as claimed in claim 49, in which the second major face is left exposed for attachment to another object.
